(19) United States
(12) Patent Application Publication
(10) Pub. No.: US 2004/0100607 A1
(43) Pub. Date: May 27, 2004

(54) Liquid crystal display

(76) Inventors: Yasushi Kawata, Ageo-shi (JP); Akio Murayama, Fukaya-shi (JP); Kazuyuki Sunohara, Kanazawa-shi (JP); Yuuzo Hisatake, Yokohama-shi (JP); Takeshi Yamaguchi, Kumagaya-shi (JP); Kisako Ninomiya, Fukaya-shi (JP); Natsuko Fujiyama, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/638,419

(22) Filed: Aug. 12, 2003

(30) Foreign Application Priority Data
Aug. 14, 2002 (JP) 2002-236497

(51) Int. Cl. G02F 1/1343

(52) U.S. Cl. 349/141

(57) ABSTRACT

There is provided a liquid crystal display including a liquid crystal display cell, a circularly polarizing device facing the liquid crystal display cell, and a quarter wave plate interposed between the liquid crystal cell and the circularly polarizing device, wherein each pixel electrode of the liquid crystal display cell includes comb-shaped conductive layers differing from each other in the longitudinal direction of the comb-teeth and electrically connected to each other.

### CROSS-REFERENCE TO RELATED APPLICATIONS

This application is based upon and claims the benefit of priority from the prior Japanese Patent Application No. 2002-236497, filed Aug. 14, 2002, the entire contents of which are incorporated herein by reference.

### BACKGROUND OF THE INVENTION

1. Field of the Invention

The present invention relates to a liquid crystal display.

2. Description of the Related Art

A liquid crystal display has various features. For example, the liquid crystal display is thin and low in power consumption. Therefore, the liquid crystal display is widely used as a display of, for example, a word processor, a notebook computer, a portable telephone or a car navigation system. Presently, in such a liquid crystal display, a TFT-TN (Thin Film Transistor-Twisted Nematic) mode that uses TFT as an active device and a nematic liquid crystal is mainly utilized. In the liquid crystal display utilizing the display mode, a screen size of about 10 inches and a full color display have been achieved, and the liquid crystal display is utilized as, for example, a display for an information terminal.

However, where the construction that permits a full color display is employed in a liquid crystal display of the TN mode, a problem that the viewing angle is rendered very narrow occurs. Also, in this case, there is another problem that the tailing of image appears when a dynamic picture image is displayed so as to deteriorate the quality of the dynamic picture image display. Such being the situation, applications of the liquid crystal display utilizing the nematic liquid crystal are restricted.

In recent years, application of the liquid crystal display to a TV receiver set as well as to the monitor of the desk top computer and the work station has come to be required. The TN mode referred to above, however, cannot achieve the viewing angle and the response time characteristics required for such uses. Under the circumstances, it is studied to employ a display mode using the nematic liquid crystal such as an OCB mode, VAN (Vertical Aligned Nematic) mode and IPS mode or a display mode using the smectic liquid crystal such as a surface stabilized ferroelectric liquid crystal mode and antiferroelectric liquid crystal mode.

In the display modes exemplified above, the VAN mode permits a response time shorter than that of the conventional TN mode and does not need a rubbing treatment that generates undesired phenomenon such as an electrostatic destroy because the homeotropic alignment is utilized in the VAN mode. Particularly, the multi-domain type VAN mode, in which each pixel region is divided into a plurality of domains differing from each other in the tilt direction of the liquid crystal molecules, attracts attentions because the compensation of the viewing angle is relatively easy.

However, the liquid crystal display of the multi-domain type VAN mode tends to be lower in transmittance than the liquid crystal display of the TN mode because of, for example, the declination that is generated as a result of the domain division. Also, in the liquid crystal display of the multi-domain type VAN mode, a sufficiently short response time has not necessarily been achieved.

### BRIEF SUMMARY OF THE INVENTION

According to a first aspect of the present invention, there is provided a liquid crystal display comprising a liquid crystal display cell comprising first and second substrates facing each other, pixel electrodes arrayed on the first substrate and facing the second substrate, a common electrode supported by the second substrate and facing the pixel electrodes, and a liquid crystal layer interposed between the pixel electrodes and the common electrode, a first circularly polarizing device facing the liquid crystal display cell, and a first quarter wave plate interposed between the liquid crystal display cell and the first circularly polarizing device, wherein the display forms first and second regions different in transmittance or reflectance from each other in a pixel region that corresponds to a region of the liquid crystal layer sandwiched between one of the pixel electrodes and the common electrode on application of voltage between the pixel electrode and the common electrode, each of the first and second regions extending in a first direction that is parallel with a surface of the liquid crystal layer, and the first and second regions being alternately arranged in a second direction crossing the first direction and parallel with the surface of the liquid crystal layer.

According to a second aspect of the present invention, there is provided a liquid crystal display comprising a liquid crystal display cell comprising first and second substrates facing each other, pixel electrodes arrayed on the first substrate and facing the second substrate, a common electrode supported by the second substrate and facing the pixel electrodes, and a liquid crystal layer interposed between the pixel electrodes and the common electrode, a first circularly polarizing device facing the liquid crystal display cell, and a first quarter wave plate interposed between the liquid crystal display cell and the first circularly polarizing device, wherein the display forms first and second regions different in the electric field intensity or tilt angle of liquid crystal molecules from each other in a pixel region that corresponds to a region of the liquid crystal layer sandwiched between one of the pixel electrodes and the common electrode on application of voltage between the pixel electrode and the common electrode, each of the first and second regions extending in a first direction that is parallel with a surface of the liquid crystal layer, and the first and second regions being alternately arranged in a second direction crossing the first direction and parallel with the surface of the liquid crystal layer.

According to a third aspect of the present invention, there is provided a liquid crystal display comprising a liquid crystal display cell comprising first and second substrates facing each other, pixel electrodes arrayed on the first substrate and facing the second substrate, a common electrode supported by the second substrate and facing the pixel electrodes, and a liquid crystal layer interposed between the pixel electrodes and the common electrode, a first circularly polarizing device facing the liquid crystal display cell, and a first quarter wave plate interposed between the liquid crystal display cell and the first circularly polarizing device, wherein each of the pixel electrodes comprises comb-shaped conductive layers different in longitudinal direction of comb-teeth from each other and electrically connected to each other.

### BRIEF DESCRIPTION OF THE SEVERAL VIEWS OF THE DRAWING

FIG. 1 is an oblique view schematically showing the liquid crystal display according to one embodiment of the present invention;

FIG. 2 is a cross sectional view schematically showing the liquid crystal display cell included in the liquid crystal display shown in FIG. 1;

FIG. 3 is a plan view schematically exemplifying the construction that can be employed in the liquid crystal display cell shown in FIG. 2;

FIGS. 4A to 4D schematically show the change in the alignment of the liquid crystal molecules that takes place in the case of employing the construction shown in FIG. 3 in the liquid crystal display cell shown in FIG. 2;

FIG. 5 exemplifies the transmittance distribution that is observed in the case of employing the construction shown in FIG. 3 in the liquid crystal display cell shown in FIG. 2;

FIG. 6 is a plan view schematically exemplifying another construction that can be utilized in the liquid crystal display cell shown in FIG. 2;

FIG. 7 schematically shows the change in the alignment of the liquid crystal molecules that takes place in the case of employing the construction shown in FIG. 6 in the liquid crystal display cell shown in FIG. 2;

FIGS. 8A to 8C are plan views schematically showing the constructions employed in Examples 1 to 3;

FIG. 9A is a graph showing the response time of the liquid crystal display for Example 1; and

FIG. 9B is a graph showing the response time of the liquid crystal display for the Comparative Example.

### DETAILED DESCRIPTION OF THE INVENTION

An embodiment of the present invention will now be described with reference to the accompanying drawings. In the accompanying drawings, the constituting elements performing the same or similar functions are denoted by the same reference numerals so as to omit the overlapping description.

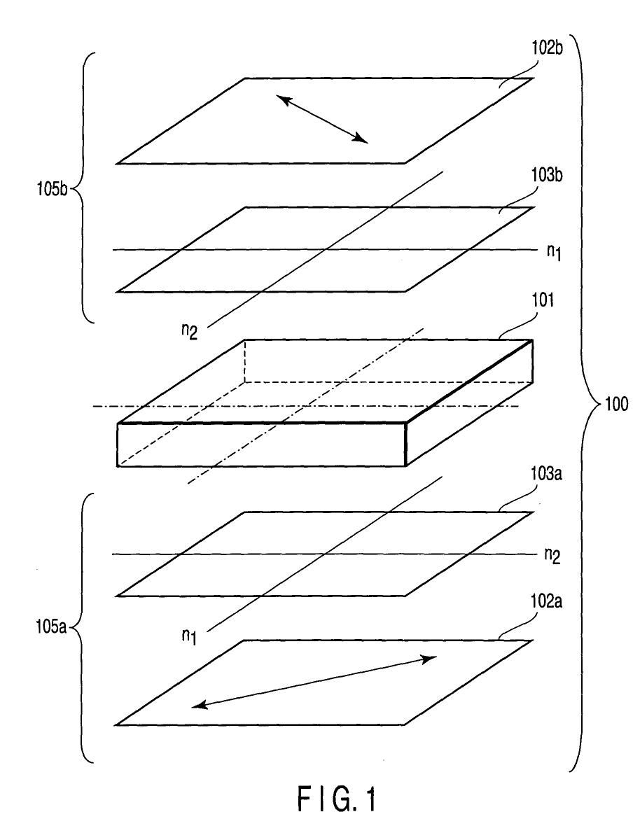

FIG. 1 is an oblique view schematically showing a liquid crystal display according to one embodiment of the present invention. The liquid crystal display 100 shown in FIG. 1 is a VAN type liquid crystal display constructed such that a liquid crystal display cell 101 is sandwiched between a pair of polarizing plates 102a and 102b. As shown in the drawing, a quarter wave plate 103a is interposed between the polarizing plate 102a and the liquid crystal display cell 101. Also, a quarter wave plate 103b is interposed between the polarizing plate 102b and the liquid crystal display cell 101. The polarizing plate 102a and the quarter wave plate 103a collectively form a circularly polarizing device 105a, and the polarizing plate 102b and the quarter wave plate 103b collectively form a circularly polarizing device 105b. Incidentally, the term “quarter wave plate” noted above includes both a retardation film and a retardation sheet, which generate a phase difference of a quarter wave between a pair of polarized light.

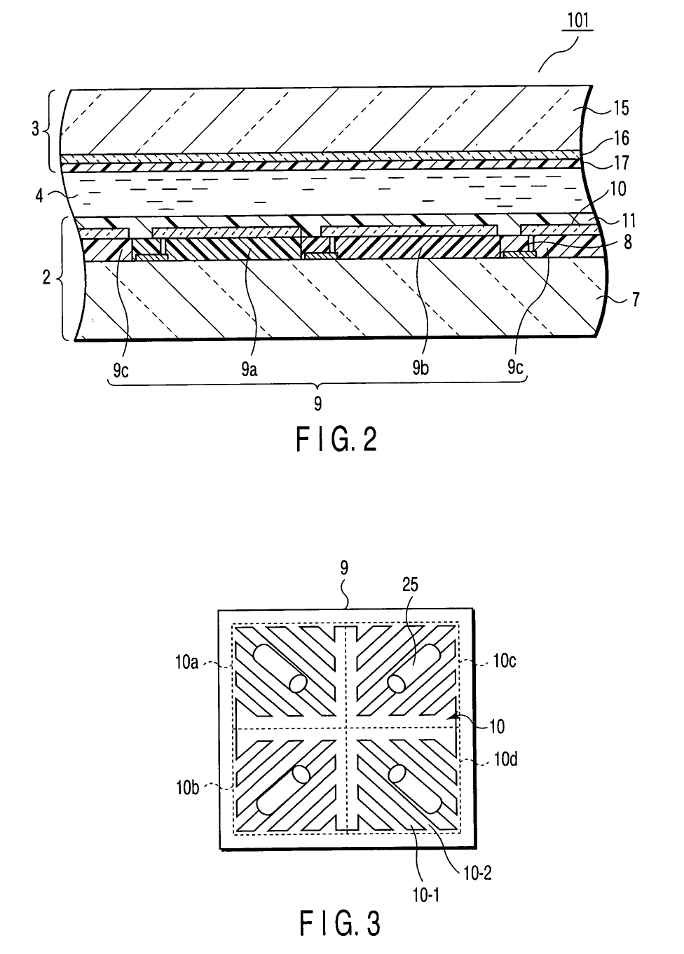

FIG. 2 is a cross sectional view schematically showing the liquid crystal display cell 101 included in the liquid crystal display 100 shown in FIG. 1. The liquid crystal display cell shown in FIG. 2 is constructed such that a liquid crystal layer 4 is sandwiched between an active matrix substrate (or an array substrate) 2 and a counter substrate 3. The clearance between the active matrix substrate 2 and the counter substrate 3 is held constant by spacers (not shown).

The active matrix substrate 2 includes a transparent substrate 7 such as a glass substrate. Wirings and switching elements 8 are formed on one main surface of the transparent substrate 7. Further, a color filter layer 9, pixel electrodes 10 and an alignment layer 11 are formed successively to cover the wirings and the switching elements 8 noted above.

The wirings formed on the transparent substrate 7 include, for example, scanning lines and signal lines each made of, for example, aluminum, molybdenum or copper. The switching element 8 is, for example, a TFT including a semiconductor layer made of, for example, an amorphous silicon or a polycrystalline silicon (polysilicon) and a metal layer made of, for example, aluminum, molybdenum, chromium, copper or tantalum, and is connected to the wirings such as a scanning line and a signal line and to the pixel electrode 10. The particular construction permits the active matrix substrate 2 to apply a voltage selectively to a desired pixel electrode 10.

The color filter layer 9 includes a blue coloring layer 9a, a green coloring layer 9b and a red coloring layer 9c. Contact holes are formed in the color filter 9 so as to permit the pixel electrodes 10 to be connected to the switching elements 9 via the contact holes. The coloring layers 9a to 9c can be formed by using a photosensitive resin containing a coloring dye or a coloring pigment.

The pixel electrode 10 can be made of a transparent conductive material such as ITO. To be more specific, the pixel electrode 10 can be formed by forming a thin film by, for example, a sputtering method, followed by patterning the thin film by employing a photolithography and an etching.

The alignment layer 11 on the pixel electrode 10 is a thin film made of a transparent resin such as polyimide. Incidentally, in the present embodiment, a rubbing treatment is not applied to the alignment layer 11, and the alignment layer 11 acts as a vertical alignment layer.

The counter substrate 3 has a structure in which a common electrode 16 and an alignment layer 17 are formed successively on a transparent substrate 15 such as a glass substrate. It is possible for the common electrode 16 and the alignment layer 17 to be made of materials similar to those used for forming the pixel electrode 10 and the alignment layer 11 of the active matrix substrate 2, respectively. Incidentally, in the present embodiment, the common electrode 16 is formed as a flat continuous film.

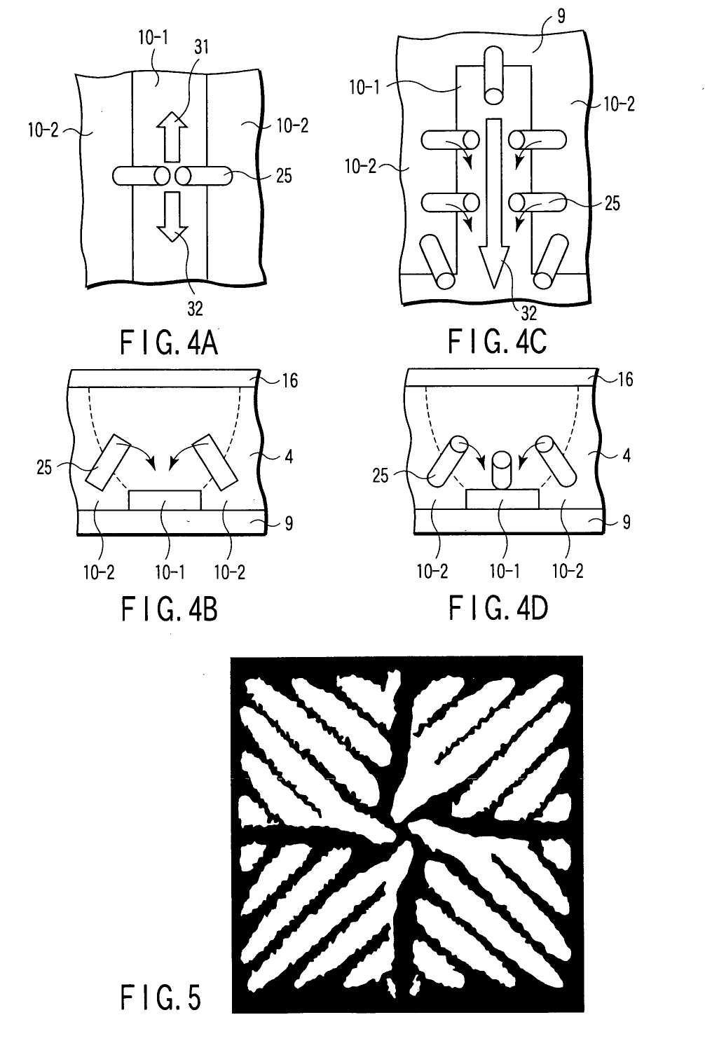

FIG. 3 is a plan view schematically exemplifying the construction that can be utilized in the liquid crystal display cell 101 shown in FIG. 2. In the construction shown in FIG. 3, a single pixel electrode 10 is formed of four comb-shaped conductive layers 10a to 10d differing from one another in the longitudinal direction of the comb-teeth and electrically connected to one another. Each of the comb-shaped conductive layers 10a to 10d is constructed such that comb-teeth portions 10-1 and slit portions 10-2 are alternately arranged. Where such a construction is utilized in the liquid crystal display cell 101 shown in FIG. 2, the pixel region can be divided into four domains differing from one another in the tilt direction of the liquid crystal molecules in conformity with the comb-shaped conductive layers 10a to 10d constituting the pixel electrode 10. The particular construction will now be described in detail with reference to FIGS. 4A to 4D.

FIGS. 4A to 4D schematically show the change in the alignment of the liquid crystal molecules that takes place in the case of employing the construction shown in FIG. 3 in the liquid crystal display cell shown in FIG. 2. Incidentally, FIGS. 4A and 4C are plan views, and FIGS. 4B and 4D are side views of the constructions shown in FIGS. 4A and 4C as viewed from the lower side in the drawing. Also, some constituents are omitted from FIGS. 4A to 4D for the sake of brevity.

Where a voltage is not applied between the pixel electrode 10 and the common electrode 16, the alignment layers 11 and 17 serve to permit liquid crystal molecules 25, which form the liquid crystal layer 4 and have a negative dielectric anisotropy in the present embodiment, to be oriented in the vertical direction. As a result, the liquid crystal molecules 25 are oriented such that the major axes of the liquid crystal molecules are rendered substantially perpendicular to the film surface of the alignment layer 11.

If a relatively low first voltage is applied between the pixel electrode 10 and the common electrode 16, a stray electric field is generated above the slit portion 10-2 formed in the pixel electrode 10. As a result, the electric flux lines are inclined as shown in FIG. 4B.

The electric field generated by application of voltage between the pixel electrode 10 and the common electrode 16 serves to permit the liquid crystal molecules 25 to be oriented in a direction perpendicular to the electric flux line. It follows that the liquid crystal molecules 25 are oriented as shown in FIG. 4A by the effects of the alignment layers 11, 17 and the electric field.

However, under the state shown in FIG. 4A, an interference is brought about between the orienting state of the liquid crystal molecules on the right side and the orienting state of the liquid crystal molecules 25 on the left side. As a result, the tilt direction of the liquid crystal molecules 25 is changed upward or downward in the drawing so as to assume a more stable alignment state.

Suppose the comb-teeth portion 10-1 and the region in the vicinity thereof are shaped symmetrical or isotropic in the up-down direction in the drawing, as shown in FIG. 4A. In this case, the probability for the tilt direction of the liquid crystal molecules 25 to be changed upward as denoted by an arrow 31 is rendered equal to the probability for the tilt direction of the liquid crystal molecules 25 to be changed downward as denoted by an arrow 32.

On the other hand, where the comb-teeth portion 10-1 and the region in the vicinity thereof are asymmetric or anisotropic in the up-down direction in the drawing, as shown in FIG. 4C, the electric flux lines are rendered asymmetric between the both edge portions of the comb-teeth portion 10-1. The electric flux lines are also rendered asymmetric between the both edge portions of the slit portion 10-2. As a result, the alignment state in which the liquid crystal molecules 25 are oriented in the direction denoted by the arrow 32 is rendered more stable than the alignment state in which the liquid crystal molecules 25 are oriented in the direction denoted by the arrow 31. It follows that the average tilt direction (director) of the liquid crystal molecules 25 extends downward as denoted by an arrow 32 in FIG. 4C.

If the voltage applied between the pixel electrode 10 and the common electrode 16 is increased to a second voltage higher than the first voltage, the effect of the electric field on the orientation of the liquid crystal molecules 25, i.e., the force to make the liquid crystal molecules 25 oriented in the direction perpendicular to the electric flux line, becomes much greater than the effect of the alignment layers 11 and 17 on the orientation of the liquid crystal molecules 25, i.e., the force to make the liquid crystal molecules 25 oriented in the vertical direction. It follows that the liquid crystal molecules 25 are caused to change the tilt angle toward the homogeneous alignment.

It should be noted that, even where the second voltage is applied between the pixel electrode 10 and the common electrode 16, the alignment state in which the liquid crystal molecules 25 are oriented in the direction denoted by the arrow 32 is more stable than the alignment state in which the liquid crystal molecules 25 are oriented in the direction denoted by the arrow 31 as in the case where the first voltage is applied between the electrodes 10 and 16. It follows that, in the case where the voltage applied between the pixel electrode 10 and the common electrode 16 is changed within a range of between the first voltage and the second voltage, the director of the liquid crystal molecules 25 is changed within a plane perpendicular to the arranging direction of the comb-teeth portions 10-1 and the slit portions 10-2. In other words, where the voltage applied between the pixel electrode 10 and the common electrode 16 is changed within a range of between the first voltage and the second voltage, the liquid crystal molecules 25 are caused to change the tilt angle while maintaining the average tilt direction within a plane perpendicular to the arranging direction of the comb-teeth portions 10-1 and the slit portions 10-2.

Therefore, by allowing the four comb-shaped conductive layers 10a to 10d to differ from one another in the longitudinal direction of the comb-teeth portion 10-1 or the slit portion 10-2, it is possible to change the tilt angle while maintaining the tilt direction of the liquid crystal molecules 25 as shown in FIG. 3. In other words, it is possible to form in a single pixel region four domains, differing from one another in the tilt direction of the liquid crystal molecules 25, only by a structure of the active matrix substrate 2. Also, in the present embodiment, it is possible to change the tilt angle while maintaining the average tilt direction of the liquid crystal molecules 25 within a plane perpendicular to the arranging direction of the comb-teeth portions 10-1 and slit portions 10-2, with the result that it is possible to achieve a high response speed. In addition, an alignment defect is unlikely to take place, and formation of domains in a pixel region takes place satisfactorily.

As described above, in the present embodiment, the image display is performed by forming a plane wave-like distribution in the intensity of an electric field within a pixel region and by controlling the optical characteristics of the liquid crystal layer 4 by changing the intensity of the electric field. In performing the control described above, an electric field stronger than that in a portion above the slit portion 10-2 is formed in a portion above the comb-teeth portion 10-1 within the liquid crystal layer 4. Therefore, in the portion above the comb-teeth portion 10-1, the liquid crystal molecules 25 are inclined more greatly than in the portion above the slit portion 10-2. In other words, the portion above the comb-teeth portion 10-1 and the portion above the slit portion 10-2 in the liquid crystal layer 4 differ from each other in the average tilt angle of the liquid crystal molecules 25. Such a difference in the tilt angle can be observed as an optical difference.

FIG. 5 exemplifies the distribution of the transmittance that is observed in the case of employing the construction shown in FIG. 3 in the liquid crystal display cell 101 shown in FIG. 2. Incidentally, FIG. 5 shows the plane wave-like distribution of the transmittance that is observed under the state that one polarizing plate (or polarizing film) is arranged on the light source side of the liquid crystal display cell 101 such that the transmittance easy axes thereof makes an angle of +45° relative to the longitudinal direction of the comb-teeth portion 10-1, another polarizing plate (or polarizing film) is arranged on the observer side of the liquid crystal display cell 101 such that the transmittance easy axes thereof makes an angle of −45° relative to the longitudinal direction of the comb-teeth portion 10-1, and a third voltage intermediate between the first voltage and the second voltage is applied between the pixel electrode 10 and the common electrode 16. As apparent from FIG. 5, the features described with reference to FIGS. 2 to 4 can be observes as optical characteristics.

Incidentally, in the transmittance distribution shown in FIG. 5, a cross-shaped dark portion is generated at the boundary portions among the comb-shaped conductive layers 10a to 10d. For achieving a brighter display, it is desirable to eliminate the presence of such a dark portion.

In the liquid crystal display 100 according to the present embodiment, the quarter wave plate 103a is interposed between the liquid crystal display cell 101 and the polarizing plate 102a, and the quarter wave plate 103b is interposed between the liquid crystal display cell 101 and the polarizing plate 102b, as shown in FIG. 1. In the case of employing the particular construction, it is possible to eliminate the generation of such a cross-shaped dark portion.

To be more specific, the cross-shaped black line abnormality described above is generated because the tilt direction of the liquid crystal molecule 25 is rendered parallel or perpendicular to the transmittance easy axis of the polarizing plate at the boundary regions among the comb-shaped conductive layers 10a to 10d. In the case of using the quarter wave plates 103a and 103b, however, a circularly polarized light is incident on the liquid crystal layer 4 in place the linearly polarized light so as to cause the dependence of the transmittance on the tilt direction to disappear. It follows that the cross-shaped black line abnormality is eliminated while displaying the bright image so as to improve the transmittance. Incidentally, the dependence of the transmittance on the tilt angle is not changed even in the case of using the quarter wave plates 103a and 103b, with the result that the dark image does not become brighter. It is also possible to observe a comb-teeth-like transmittance distribution corresponding to the comb-teeth portion 10-1 and the slit portion 10-2.

In the case of using the quarter wave plates 103a and 103b, an apparent response time can also become short as described in the following in addition to the increase in the transmittance during the bright display. In the process of the alignment change of the liquid crystal molecules 25 after the voltage application, the liquid crystal molecule 25 falls down first and, then, the tilt direction of the fallen liquid crystal molecule 25 is changed (rotated). Since the dependence of the transmittance on the tilt direction is eliminated in the case of using the quarter wave plates 103a and 103b as described above, the change in the transmittance is finished at the time when the liquid crystal molecule 25 falls down. For this reason, the apparent response time becomes short.

In the construction described above with reference to FIGS. 3 to 5, the comb-teeth portion 10-1 and the slit portion 10-2 are assumed to have a constant width. However, it is possible to change the width of each of the comb-teeth portion 10-1 and the slit portion 10-2 in the longitudinal direction thereof.

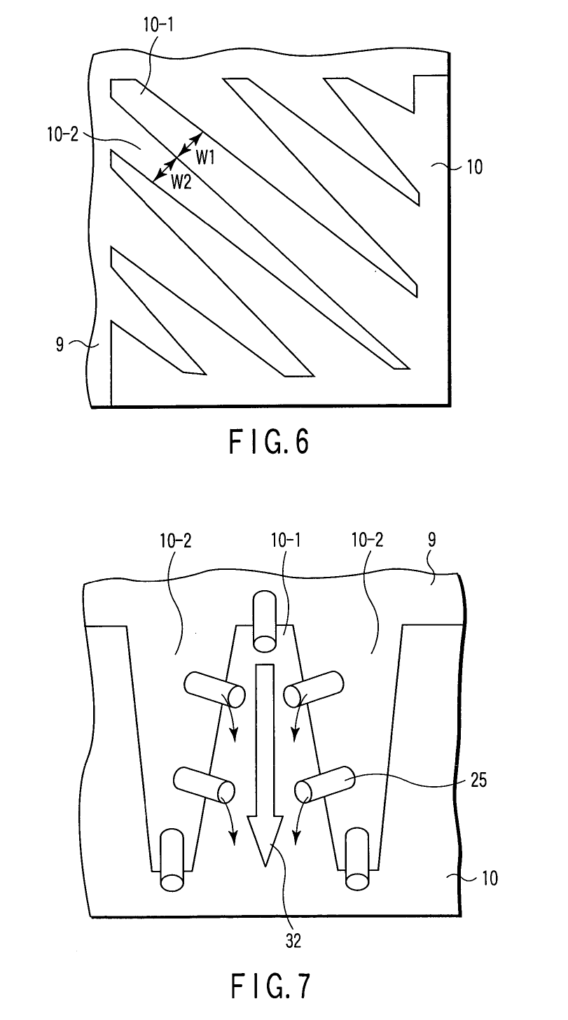

FIG. 6 is a plan view schematically showing another example of the construction that can be employed in the liquid crystal display cell 101 shown in FIG. 2. FIG. 7 is a view schematically showing the change in the alignment of the liquid crystal molecules that takes place in the case of employing the construction shown in FIG. 6 in the liquid crystal display cell shown in FIG. 2. Incidentally, FIG. 6 shows one of the comb-shaped conductive layers 10a to 10d collectively forming the pixel electrode 10, i.e., the comb-shaped conductive layer 10a. On the other hand, FIG. 7 shows only a part of the conductive layer 10a shown in FIG. 6.

In the construction shown in FIGS. 6 and 7, the width of the comb-teeth portion 10-1 is consecutively decreased from the central portion of the pixel electrode 10 toward the periphery, and the width of the slit portion 10-2 is consecutively increased from the central portion of the pixel electrode 10 toward the periphery. In the case of employing the particular construction, the liquid crystal alignments at both side edge portions of the comb-teeth portion 10-1 and the slit portion 10-2 in addition to the liquid crystal alignment in the upper edge portion of the comb-teeth portion 10-1 and the liquid crystal alignment in the lower edge portion of the slit portion 10-2 affect the director to orient in the direction as denoted by an arrow 32. As a result, the construction shown in FIGS. 6 and 7 permits further increasing the transmittance and also permits further shortening the response time.

In the description given above, the pixel electrode 10 is formed of the comb-shaped conductive layers 10a to 10d each including the comb-teeth portion 10-1 and the slit portion 10-2. By this particular construction, an electric field distribution in which a region having a lower electric field intensity and a region having a higher electric field intensity are alternately arranged periodically was generated in each domain. In the case of utilizing the comb-shaped conductive layers 10a to 10d, it is possible to design the liquid crystal display with a relatively high degree of freedom. However, the particular distribution of the electric field can also be generated by another method.

For example, it is possible to form a dielectric layer to have a pattern similar to that of the slit portion 10-2 on the pixel electrode 10 that has a general shape, i.e., the pixel electrode 10 with no slit portion 10-2. In this case, it is possible to form a region having an electric field of a weak intensity above the dielectric layer, if the dielectric layer is made of a material having a dielectric constant lower than that of the liquid crystal material such as acrylic resins, epoxy resins or novolac resins. It follows that the effect similar to that obtained in the case of forming the slit portion 10-2 can also be obtained in this case.

It is also possible to form a wiring above the pixel electrode 10 of the general shape, i.e., the pixel electrode 10 with no slit portion 10-2, with a transparent insulating material interposed therebetween. The wiring, which is, for example, a signal line, a gate line or a auxiliary capacitor line, can be arranged to form a pattern similar to that of the slit portion 10-2. The particular construction makes it possible to form a region having an electric field of a higher intensity above the wiring. It follows that the effect similar to that obtained in the case of forming the slit portion 10-2 can also be obtained in this case, too.

Incidentally, where the liquid crystal display 100 is of a transmissive type, it is desirable in terms of the transmittance to use a transparent material for forming the dielectric layer and the wiring referred to above. Also, where the liquid crystal display 100 is of a reflective type, it is possible to use an opaque material such as a metallic material in addition to the transparent material for forming the dielectric layer and the wiring referred to above.

In the embodiment described above, it is desirable for the sum W₁₂ of a width W₁ of the region with a higher electric field intensity and a width W₂ of the region with a lower electric field intensity to be 20 μm or less. Generally, if the sum W₁₂ of the widths is not larger than 20 μm, the alignment of the liquid crystal molecules can be controlled as described above so as to achieve a sufficiently high transmittance. On the other hand, it is desirable for the sum W₁₂ to be not smaller than 6 μm. Generally, if the sum W₁₂ is not smaller than 6 μm, it is possible to form with a sufficiently high precision the structure that permits forming a region having a stronger electric field and another region having a weaker electric field within the liquid crystal layer 4. In addition, it is possible to stably produce the above described liquid crystal alignment.

Incidentally, the sum W₁₂ noted above is substantially equal to the sum of the width of the comb-teeth portion 10-1 and the width of the slit portion 10-2 of the pixel electrode 10, the sum of the width of the region sandwiched between the dielectric layers formed on the pixel electrode 10 and the width of the dielectric layer, the sum of the width of the wiring formed on the pixel electrode 10 and the width of the region sandwiched between the adjacent wirings, the sum of the width of the region having a larger tilt angle and the width of the region having a smaller tilt angle during application of the third voltage, or the sum of the width of region having a higher transmittance and the width of the region having a lower transmittance during application of the third voltage. It follows that it is desirable for the value of each of the sums of the widths referred to above to fall within a range of between 6 μm and 20 μm.

In the present embodiment, it is desirable for each of the widths W₁ and W₂ to be not larger than 8 μm. Also, it is desirable for each of the widths W₁ and W₂ to be not smaller than 4 μm. Where each of these widths W₁ and W₂ falls within a range of between 4 μm and 8 μm, a practically sufficient performance can be expected in respect of the response time and the transmittance.

Incidentally, the width W₁ and W₂ in question correspond, respectively, to the width of the comb-teeth portion 10-1 and the width of the slit portion 10-2 of the pixel electrode 10, the width of the region sandwiched between the dielectric layers formed on the pixel electrode 10 and the width of the dielectric layer, the width of the wiring formed on the pixel electrode 10 and the width of the region sandwiched between the adjacent wirings, the width of the region having a larger tilt angle and the width of the region having a smaller tilt angle during application of the third voltage, or the width of region having a higher transmittance and the width of the region having a lower transmittance during application of the third voltage. It follows that it is desirable for each of these widths to fall within a range of between 4 μm and 8 μm.

In the present embodiment, it suffices for the length of the region having a stronger electric field and the length of the region having a weaker electric field within the liquid crystal layer 4 to be larger than the widths W₁ and W₂, respectively. However, it is desirable for each of the lengths of the regions referred to above to be at least twice as much as W12, which is the sum of W₁ and W₂. In this case, it is possible to permit a larger portion of the liquid crystal molecules to be aligned in the longitudinal direction of each of the regions noted above.

In the present embodiment, both the region having a stronger electric field and the region having a weaker electric field within the liquid crystal layer 4 are rendered asymmetric in the vertical direction as shown in FIG. 4C. However, it is possible to allow these regions to be symmetric in the vertical direction as shown in FIG. 4A. The former case is advantageous in, for example, the response time.

In the present embodiment, employed is a VAN mode in which nematic liquid crystal molecules having a negative dielectric anisotropy are vertically aligned. Alternatively, it is also possible to use nematic liquid crystal molecules having a positive dielectric anisotropy. Particularly, where a high contrast is desired, it is possible to achieve a high contrast not lower than, for example, 400:1 and a brighter screen design based on a high transmittance design, by employing a VAN mode and a normally black mode.

In the present embodiment, it is possible to permit the angle made between the transmittance easy axis or absorption axis of the polarizing films 102a and 102b and the aligning direction of the regions having a strong electric field and a weak electric field to be deviated by a predetermined angle θ from 45° in order to increase the apparent optical response of the liquid crystal. The angle θ can be set in accordance with, for example, the viewing angle.

In order to shorten the response time, it is most effective to set the angle θ at 22.5°.

In the present embodiment, the shapes of the comb-shaped conductive layers 10a to 10d collectively forming the pixel electrode 10 are not particularly limited. For example, it is possible for the shapes noted above to be rectangular or fan-shaped. Also, in the present embodiment, the pixel electrode is formed of four comb-shaped conductive layers. However, the number of comb-shaped conductive layers is not particularly limited as far as a plurality of comb-shaped conductive layers are included in the pixel electrode.

In the present embodiment, the structure, which permits forming a region having an electric field of a higher intensity and a region having an electric field of a lower intensity within the liquid crystal layer during application of the third voltage, is formed only in the active matrix substrate 2. However, it is possible to form a structure in each of the active matrix substrate 2 and the counter substrate 3 in order to form a region having an electric field of a higher intensity and a region having an electric field of a lower intensity within the liquid crystal layer during application of the third voltage. It should be noted in this connection that, in the former case, high precision positioning utilizing, for example, an alignment mark is rendered unnecessary in forming a cell by bonding the active matrix substrate 2 to the counter substrate 3.

Further, in each of the present embodiment, employed is a COA (color filter on array) structure in which color filter 9 is disposed on the active matrix substrate 2. However, it is also possible to dispose the color filter 9 on the counter substrate 3. It should be noted in this connection that, in the former case, high precision positioning utilizing, for example, an alignment mark is rendered unnecessary in forming a cell by bonding the active matrix substrate 2 to the counter substrate 3.

Further, in the present embodiment, the liquid crystal display 100 is of a transmissive type. However, it is also possible for the liquid crystal display 100 to be of a reflective type. In this case, it is unnecessary to use the circularly polarizing device 105a if the upper side in FIG. 1 provides the observer's side.

Some Examples of the present invention will now be described.

### EXAMPLE 1

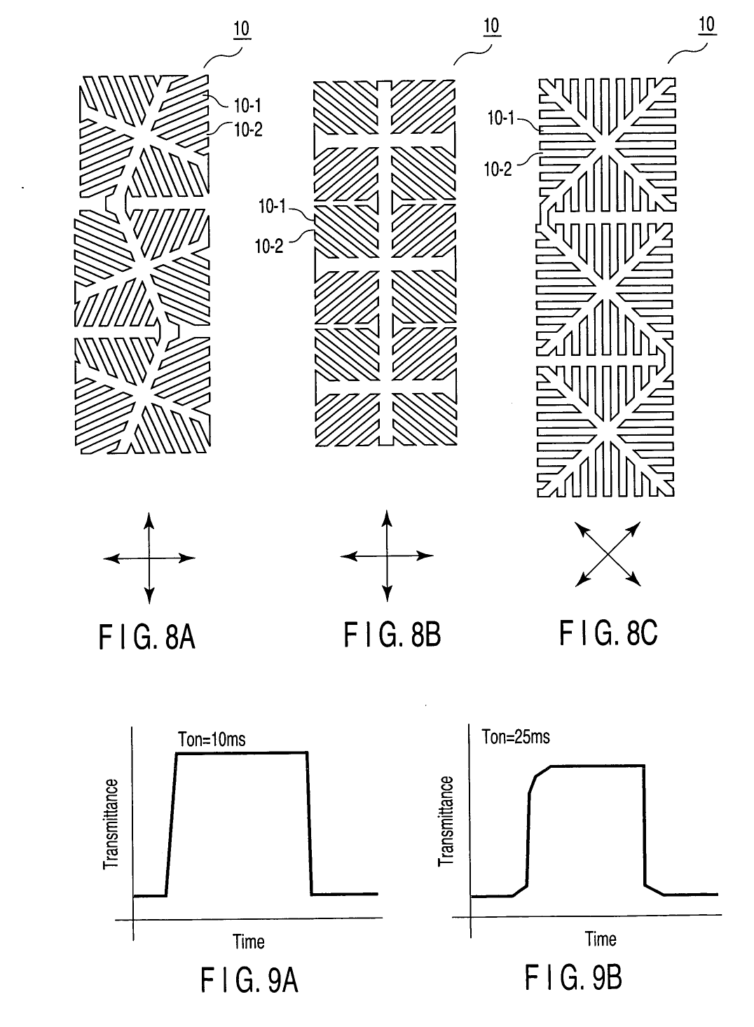

In this Example, the liquid crystal display 100 shown in FIG. 1 was manufactured as follows. Incidentally, the pixel electrode 10 was shaped as shown in FIG. 8A.

First, the wirings including scanning lines and signal lines and TFTs 8 were formed on a glass substrate 7 by repeating a film formation and pattering by the process similar to the ordinary TFT forming process. Then, a color filter layer 9 was formed by the ordinary method on that surface of the glass substrate 7 on which the TFT 8 etc. were formed.

Next, an ITO film was formed by a sputtering method on that surface of the glass substrate 7 on which the color filter layer 9 was formed with a mask of a prescribed pattern interposed therebetween. Then, a resist pattern was formed on the ITO film, followed by etching the exposed portion of the ITO film with the resist pattern used as a mask. In this fashion, formed were the pixel electrodes 10 constructed as shown in FIG. 8A. Incidentally, each of the comb-teeth portion 10-1 and the slit portion 10-2 of the pixel electrode 10 had a width of 5 μm.

Then, the entire surface of the glass substrate 7 having the pixel electrode 10 formed thereon was coated with a thermosetting resin, followed by baking the coated film so as to form a vertical alignment layer 11 having a thickness of 70 nm. In this fashion, an active matrix substrate 2 was prepared.

On the other hand, an ITO film was formed as a common electrode 16 by a sputtering method on one of the main surfaces of another glass substrate 15. Then, a vertical alignment layer 17 was formed on the entire surface of the common electrode 16 by a method described above in conjunction with the active matrix substrate 2. As a result, a counter substrate 3 was prepared.

Next, a liquid crystal display cell 101 constructed as shown in FIG. 2 was obtained by bonding the peripheral portions of the active matrix substrate 2 and the counter substrate 3 to each other with an adhesive such that a free space (or a cell gap) is formed between the active matrix substrate 2 and the counter substrate 3, that the alignment layers 11 and 17 noted above were allowed to face each other, and that an injecting port for injecting a liquid crystal material into the cell gap noted above is left open. Incidentally, the cell gap of the liquid crystal display cell 101 was maintained constant by allowing a resin body having a height of 4 μm to be interposed as a spacer between the active matrix substrate 2 and the counter substrate 3. Also, in bonding the substrates 2 and 3 to each other, the edge portions of the active matrix substrate 2 and the counter substrate 3 were aligned so as to position the active matrix substrate 2 and the counter substrate 3. In other words, high precision positioning utilizing, for example, an alignment mark, was not performed.

Next, a liquid crystal material having a negative dielectric anisotropy was injected into the vacant liquid crystal display cell 101 by the ordinary method so as to form the liquid crystal layer 4. After formation of the liquid crystal layer 4, the liquid crystal injecting port was sealed with an ultraviolet curing resin. Then, quarter wave plates 103a and 103b were attached to both sides of the liquid crystal display cell 101, followed by attaching the polarizing films 102a and 102b to the quarter wave plates 103a and 103, respectively, so as to obtain the liquid crystal display 100 as shown in FIG. 1. It should be noted that the polarizing films 102a and 102b were attached such that the transmittance easy axes thereof, which are denoted by both-sided arrows in FIG. 8A, made an angle of 22.5° or 67.5° with the boundaries among the comb-shaped conductive layers 10a to 10d, as shown in the drawing. Also, the quarter wave plates 103a and 103b were attached such that the optical axes thereof made an angle of 45° with the transmittance easy axes of the polarizing films 102a and 102b, respectively, and that the optical axes of the quarter wave plates 103a and 103b extended in directions perpendicular to each other, as shown in FIG. 1. Incidentally, it was possible to drive the liquid crystal display 100 by changing the voltage applied between the pixel electrode 10 and the common electrode 16 within a range of between about 1.5V and about 5V.

Then, the liquid crystal display 100 thus manufactured was observed under the state that a voltage of 5V was kept applied between the pixel electrode 10 and common electrode 16. As a result, observed was a distribution of the transmittance corresponding to the comb-teeth portion 10-1 and the slit portion 10-2 of the pixel electrode 10. However, a cross-shaped dark portion corresponding to the boundaries among the comb-shaped conductive layers 10a to 10d was not recognized.

### COMPARATIVE EXAMPLE

A liquid crystal display 100 as shown in FIG. 1 was prepared by a method similar to the method described above in conjunction with Example 1. In Comparative Example, however, the quarter wave plates 103a and 103b were not used. The liquid crystal display 100 thus manufactured was observed under the state that a voltage of 5V was kept applied between the pixel electrode 10 and the common electrode 16. As a result, observed was a distribution of the transmittance corresponding to the comb-teeth portion 10-1 and the slit portion 10-2 of the pixel electrode 10 together with a dark portion corresponding to the boundaries among the comb-shaped conductive layers 10a to 10d.

Next, in respect of the liquid crystal display 100 manufactured in Example 1 and the liquid crystal display manufactured in the Comparative Example, a voltage of 5V was applied between the pixel electrode 10 and the common electrode 16 in order to examine a transmittance change with time from the initiation of the voltage application. In other words, examined was an apparent response time.

FIG. 9A is a graph showing the response time of the liquid crystal display 100 for Example 1, and FIG. 9B is a graph showing the response time of the liquid crystal display for the Comparative Example. In the graph of each of FIGS. 9A and 9B, the lapse of time from the initiation of the voltage application is plotted on the abscissa, with the transmittance being plotted on the ordinate. As shown in FIGS. 9A and 9B, the response time Ton, which denotes the time between the initiation of the voltage application and the completion in the change of the transmittance, was 25 ms for the liquid crystal display for the Comparative Example. On the other hand, the response time was shortened to 10 ms, which is shorter than half the response time for the Comparative Example, in the liquid crystal display 100 for Example 1. Also, the transmittance obtained in the liquid crystal display 100 for Example 1 was higher than that obtained in the liquid crystal display for the Comparative Example.

### EXAMPLE 2

A liquid crystal display 100 constructed as shown in FIG. 1 was manufactured as in Example 1, except that the pixel electrode 10 was shaped as shown in FIG. 8B, and that each of the comb-teeth portion 10-1 and the slit portion 10-2 of the pixel electrode 10 had a width of 4 μm. Incidentally, it was possible to drive the liquid crystal display 100 by, for example, changing the voltage applied between the pixel electrode 10 and the common electrode 16 within a range of between about 1.5V and about 5V.

Then, the liquid crystal display 100 thus manufactured was observed under the state that a voltage of 5V was kept applied between the pixel electrode 10 and common electrode 16. As a result, observed was a distribution of the transmittance corresponding to the comb-teeth portion 10-1 and the slit portion 10-2 of the pixel electrode 10. However, a cross-shaped dark portion corresponding to the boundaries among the comb-shaped conductive layers 10a to 10d was not recognized. Also, the response time and the transmittance for the liquid crystal display 100 thus obtained were found to be substantially equal to those for the liquid crystal display 100 for Example 1.

### EXAMPLE 3

A liquid crystal display 100 constructed as shown in FIG. 1 was manufactured as in Example 1, except that the pixel electrode 10 was shaped as shown in FIG. 8C. Incidentally, it was possible to drive the liquid crystal display 100 by, for example, changing the voltage applied between the pixel electrode 10 and the common electrode 16 within a range of between about 1.5V and about 5V.

Then, the liquid crystal display 100 thus manufactured was observed under the state that a voltage of 5V was kept applied between the pixel electrode 10 and common electrode 16. As a result, observed was a distribution of the transmittance corresponding to the comb-teeth portion 10-1 and the slit portion 10-2 of the pixel electrode 10. However, a cross-shaped dark portion corresponding to the boundaries among the comb-shaped conductive layers 10a to 10d was not recognized. Also, the response time and the transmittance for the liquid crystal display 100 thus obtained were found to be substantially equal to those for the liquid crystal display 100 for Example 1.

As described above, where the tilt directions of the liquid crystal molecules are controlled by forming an electric field intensity distribution having a prescribed pattern within the pixel region so as to divide the pixel region into a plurality of domains differing from each other in the tilt direction of the liquid crystal molecule, a dark portion is generated on displaying a bright image because, in the boundary regions among the domains, it is impossible to control the tilt direction of the liquid crystal molecules in a desired direction. Also, in this case, a long time is necessary for stabilization of the transmittance from the voltage application because a relatively long time is required until the tilt direction is stabilized in the boundary regions among these domains.

On the other hand, in the art described above, since incident on the liquid crystal layer is not the linearly polarized light but the circularly polarized light by interposing a quarter wave plate between the liquid crystal display cell and the polarizing plate, the dependence of the transmittance on the tilt direction of the liquid crystal molecule is eliminated. Therefore, it is possible to prevent a dark portion from being generated at the boundary regions among the domains on displaying a bright image. It is also possible to shorten the time required for the transmittance to be stabilized. In other words, according to the art described above, it is possible to achieve both a high transmittance and a short response time even in the case of employing a multi-domain type VAN mode.

Additional advantages and modifications will readily occur to those skilled in the art. Therefore, the present invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display comprising:
a liquid crystal display cell comprising first and second substrates facing each other, pixel electrodes arrayed on the first substrate and facing the second substrate, a common electrode supported by the second substrate and facing the pixel electrodes, and a liquid crystal layer interposed between the pixel electrodes and the common electrode;
a first circularly polarizing device facing the liquid crystal display cell; and
a first quarter wave plate interposed between the liquid crystal display cell and the first circularly polarizing device,
wherein the display forms first and second regions different in transmittance or reflectance from each other in a pixel region that corresponds to a region of the liquid crystal layer sandwiched between one of the pixel electrodes and the common electrode on application of voltage between the pixel electrode and the common electrode, each of the first and second regions extending in a first direction that is parallel with a surface of the liquid crystal layer, and the first and second regions being alternately arranged in a second direction crossing the first direction and parallel with the surface of the liquid crystal layer.

2. The display according to claim 1, further comprising:
a second circularly polarizing device, the first and second circularly polarizing devices sandwiching the liquid crystal display cell; and
a second quarter wave plate interposed between the liquid crystal display cell and the second circularly polarizing device.

3. The display according to claim 1, wherein the liquid crystal layer contains a liquid crystal material with negative dielectric anisotropy.

4. The display according to claim 1, further comprising:
a first vertical alignment layer disposed on the pixel electrodes; and
a second vertical alignment layer disposed on the common electrodes.

5. The display according to claim 1, further comprising:
a first vertical alignment layer disposed on the pixel electrodes; and
a second vertical alignment layer disposed on the common electrodes,
wherein the liquid crystal layer contains a liquid crystal material with negative dielectric anisotropy.

6. The display according to claim 1, wherein each of the pixel electrodes comprises comb-shaped conductive layers different in longitudinal direction of comb-teeth from each other and electrically connected to each other.

7. A liquid crystal display comprising:
a liquid crystal display cell comprising first and second substrates facing each other, pixel electrodes arrayed on the first substrate and facing the second substrate, a common electrode supported by the second substrate and facing the pixel electrodes, and a liquid crystal layer interposed between the pixel electrodes and the common electrode;
a first circularly polarizing device facing the liquid crystal display cell; and
a first quarter wave plate interposed between the liquid crystal display cell and the first circularly polarizing device,
wherein the display forms first and second regions different in the electric field intensity or tilt angle of liquid crystal molecules from each other in a pixel region that corresponds to a region of the liquid crystal layer sandwiched between one of the pixel electrodes and the common electrode on application of voltage between the pixel electrode and the common electrode, each of the first and second regions extending in a first direction that is parallel with a surface of the liquid crystal layer, and the first and second regions being alternately arranged in a second direction crossing the first direction and parallel with the surface of the liquid crystal layer.

8. The display according to claim 7, wherein the first and second regions are different in electric-field intensity from each other.

9. The display according to claim 7, wherein the first and second regions are different in tilt angle of the liquid crystal molecules from each other.

10. The display according to claim 7, further comprising:
a second circularly polarizing device, the first and second circularly polarizing devices sandwiching the liquid crystal display cell; and
a second quarter wave plate interposed between the liquid crystal display cell and the second circularly polarizing device.

11. The display according to claim 7, wherein the liquid crystal layer contains a liquid crystal material with negative dielectric anisotropy.

12. The display according to claim 7, further comprising:
a first vertical alignment layer disposed on the pixel electrodes; and
a second vertical alignment layer disposed on the common electrodes.

13. The display according to claim 7, further comprising:
a first vertical alignment layer disposed on the pixel electrodes; and
a second vertical alignment layer disposed on the common electrodes,
wherein the liquid crystal layer contains a liquid crystal material with negative dielectric anisotropy.

14. The display according to claim 7, wherein each of the pixel electrodes comprises comb-shaped conductive layers different in longitudinal direction of comb-teeth from each other and electrically connected to each other.

15. A liquid crystal display comprising:
a liquid crystal display cell comprising first and second substrates facing each other, pixel electrodes arrayed on the first substrate and facing the second substrate, a common electrode supported by the second substrate and facing the pixel electrodes, and a liquid crystal layer interposed between the pixel electrodes and the common electrode;
a first circularly polarizing device facing the liquid crystal display cell; and
a first quarter wave plate interposed between the liquid crystal display cell and the first circularly polarizing device,
wherein each of the pixel electrodes comprises comb-shaped conductive layers different in longitudinal direction of comb-teeth from each other and electrically connected to each other.

16. The display according to claim 15, further comprising:
a second circularly polarizing device, the first and second circularly polarizing devices sandwiching the liquid crystal display cell; and
a second quarter wave plate interposed between the liquid crystal display cell and the second circularly polarizing device.

17. The display according to claim 15, wherein the liquid crystal layer contains a liquid crystal material with negative dielectric anisotropy.

18. The display according to claim 15, further comprising:
a first vertical alignment layer disposed on the pixel electrodes; and
a second vertical alignment layer disposed on the common electrodes.

19. The display according to claim 15, further comprising:
a first vertical alignment layer disposed on the pixel electrodes; and
a second vertical alignment layer disposed on the common electrodes,
wherein the liquid crystal layer contains a liquid crystal material with negative dielectric anisotropy.
